(19) United States
(12) Patent Application Publication
(10) Pub. No.: US 2019/0323217 A1
(43) Pub. Date: Oct. 24, 2019

(54) Fastener for pivot rod to clevis

(71) Applicant: Michael Allan Benoist, Camp Hill, PA (US)

(72) Inventor: Michael Allan Benoist, Camp Hill, PA (US)

(21) Appl. No.: 15/959,203

(22) Filed: Apr. 21, 2018

(51) Int. Cl. E03C 1/23; F16B 17/00

(52) U.S. Cl. CPC E03C 1/2302; F16B 17/006

(57) ABSTRACT

This invention seeks to improve the existing attachment method for the pivot rod and clevis, parts of a sink pop-up drain assembly. The pivot rod at the open end is guided through a hole in the clevis to set the desired lift height of the sink drain stopper. The existing fastener used to attach the pivot rod to the clevis is only a single spring clip. This configuration is susceptible to slippage, causing detachment of the pivot rod from the clevis, therefore rendering the pop-up mechanism inoperable. My new improved fastening method uses a threaded pivot rod with hardware on both sides of the clevis to prevent slippage and provide a more reliable means of attachment.

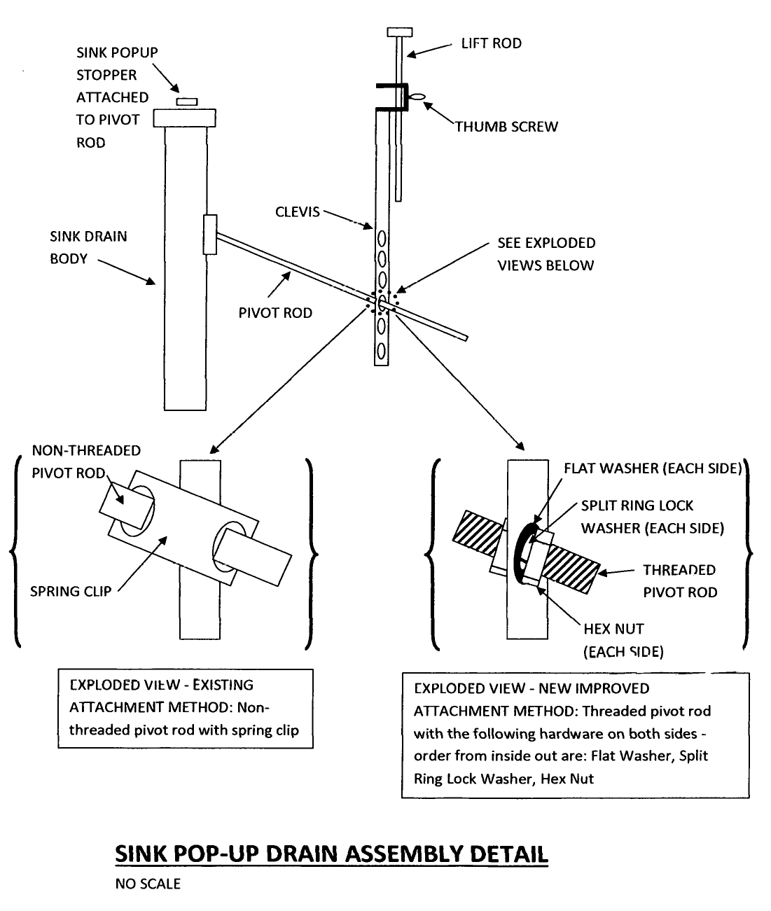

### CROSS-REFERENCE TO RELATED APPLICATIONS

Not Applicable

### STATEMENT REGARDING FEDERALLY SPONSORED RESEARCH OR DEVELOPMENT (IF APPLICABLE)

Not Applicable

### REFERENCE TO SEQUENCE LISTING, A TABLE, OR A COMPUTER PROGRAM LISTING COMPACT DISC APPENDIX (IF APPLICABLE)

Not Applicable

### BACKGROUND OF THE INVENTION

The field of endeavor pertains to a sink pop-up drain assembly for the improvement to an existing attachment method. This endeavor seeks to replace the unreliable existing fastener which uses a non-threaded pivot rod and a spring clip to attach the pivot rod to the clevis. The problem with this existing attachment method is that the spring clip is susceptible to slipping off the pivot rod during user operation from applied mechanical forces to the lift rod which causes it to detach from the clevis. This condition renders the pop-up assembly inoperable—unable to move the stopper up or down. To fix, you must crawl under the sink to reattach the spring clip to the pivot rod and clevis.

### BRIEF SUMMARY OF THE INVENTION

Solves existing problem as described in the Background of the Invention section by using a more reliable fastening method. This new and improved method employs a threaded pivot rod with fastening hardware on both sides of the clevis to provide a more secure method of attachment.

### BRIEF DESCRIPTION OF THE SEVERAL VIEWS OF THE DRAWING

There is one drawing that describes the existing sink pop-up drain assembly, and the area of interest using two exploded views, one showing the existing attachment method and one showing the new improved attachment method as described by this patent application.

### DETAILED DESCRIPTION OF THE INVENTION

This invention seeks to improve the existing method of fastening the pivot rod to the clevis by the following:

A. Elimination of the existing spring clip.
B. Adding threads to existing universal pivot rod, a four inch threaded section on the clevis side of the pivot rod, from end tip to past the midpoint of the pivot rod.
C. Include hardware sized to fit the threaded pivot rod (from B) as follows: two hex nuts, two flat washers, and two split ring lock washers.
D. Fastening procedures for this improvement are as follows:
1. Attach hardware (from C) to the threaded pivot rod in the following order: hex nut>split ring lock washer>flat washer.
2. Attach the clevis to the pivot rod through the desired hole in the clevis.
3. Attach hardware (from C) to the threaded pivot rod in the following order: flat washer>split ring lock washer>hex nut.
4. Tighten hex nuts with wrench to intersecting location of the pivot rod and clevis.

1. Replace existing non-threaded pivot rod and spring clip to attach to the clevis with a new improved fastening method which includes a threaded pivot rod attached to the clevis using the following hardware on both sides, order from inside out are: flat washer, split ring lock washer, hex nut.
